(19) United States
(12) Patent Application Publication
(10) Pub. No.: US 2004/0249877 A1
(43) Pub. Date: Dec. 9, 2004

(54) Fast integer division with minimum number of iterations in substraction-based hardware divide processor

(75) Inventors: Guenter Gerwig, Simmozheim (DE); Holger Wetter, Well im Schoembuch (DE)

Correspondence Address: Andrew J. Wojnicki, Jr., IBM Corporation, MS P386, 2455 South Road, Poughkeepsie, NY, 12601, US

(73) Assignee: International Business Machines Corporation, Armonk, NY

(21) Appl. No.: 10/861,152

(22) Filed: Jun. 4, 2004

(30) Foreign Application Priority Data
Jun. 5, 2003 (DE) 09101652.0

(51) Int. Cl. G06F 7/52

(52) U.S. Cl. 708/650

(57) ABSTRACT

A method and system for performing integer divisions using subtraction-based division processes in a hardware divide processor primarily dedicated for floating-point division processes. In particular, the method and system involve calculating a quotient of a dividend and a divisor, the dividend and divisor being binary coded integer values, by normalizing the divisor and the dividend, determining a number of binary digits (nV) needed to represent the divisor and a number of binary digits (nD) needed to represent the dividend, determining a number of effective binary digits (nQ) needed to represent the quotient, determining a start bit position to start a subtraction-based divide process, and performing the subtraction-based divide process only for bit positions beginning at the start bit position and at a least significant bit position. In preferred embodiments, the subtraction-based divide process is an SRT (Sweeney, Robinson, Tocher) Divide process.

### FIELD OF THE INVENTION

The present invention relates to a method and respective system for performing integer divisions using subtraction-based division processes in a hardware divide processor primarily dedicated for floating-point division processes.

### BACKGROUND

State-of-the-art computer architecture often includes a hardware divide processor primarily dedicated for the division of floating-point numbers. Such floating point hardware divide processors are frequently also used for the division of integer numbers. The advantage is to save separate hardware circuits for providing particular Integer division circuitry.

Assume for example that a Dividend D is divided by a Divisor V having as result a Quotient Q and a Remainder R.

Q=(D/V)−R

Normally 32 or 64 (or 128) bit wide operands are used. In the following examples a width of 64 bit is assumed.

As mentioned above, fast Integer divisions are typically executed using the Divide hardware of a floating-point unit. This is faster compared to a millicode execution in the Fixed Point Unit (FXU), i.e. the execution unit to do Fixed Point operations.

There are different hardware implementations for Integer divisions in prior art. One example is the hardware implementation of divide processes with the so-called SRT algorithm, (Sweeney, Robinson, Tocher), which is performed in a number of iterations.

The Partial Remainder for a next iteration is calculated as follows:

Pᵢ₊₁=(r*Pᵢ)−_{qi+1}*V

The Quotient is the concatenation of all partial quotient digits (qi's).

In a state-of-the-art implementation, as disclosed in U.S. Pat. No. 5,258,944, titled “HIGH PERFORMANCE MANTISSA DIVIDER”, q0 is placed in the most significant position of the Quotient Register. The next lower quotient digit q1 is concatenated right to that and so on, until the final width is reached. The number of iterations depends on the radix of the SRT division (if 4—this leads to 2 quotient bits per iteration) and on the width of the target format (here 64).

Under the above assumptions a number of 32 iterations are needed to calculate a quotient of 64 bit width.

With reference to FIG. 1, the basics of prior art Integer Division are illustrated as follows.

First, the normalized Divisor is loaded into a Divisor Register 10, and the normalized Dividend is loaded into a Partial Remainder Register 18. Then, a number of 32 Divide iterations are executed, providing two quotient bits per iteration. During a single iteration, the quotient bits are estimated within a table 12, where the two most significant bits of the Divisor Register and the 5 most significant bits of the Partial Remainder Register are used as source. In an exemplary radix-4 SRT implementation with maximum redundancy, the estimated value for qi is in the range of {−3, −2, −1, 0, +1, +2, +3}.

In the first iteration, qi is written to bit positions 0-1 of the Quotient Register 20. In the second iteration, bit positions 2-3 are written and so on. In total, a number of 32 iterations are needed to have written all 64 bit positions of the Quotient Register.

As, however, the architecture of floating-point division circuitry is always seeking to keep the width of floating-point numbers constant at a width of for example 64 bit, and due to the fact that in floating-point divisions one always intends to keep a certain fixed precision for the resulting quotient, a simple Integer division (such as, for example, 12/7) means wasting a considerable number of cycles, if the division is performed with such floating-point division circuitry under regular state-of-the-art conditions, because the most part of the calculation consists in dividing a zero digit by “7”, as all leading zeros are processed.

In fact, benchmark tests have shown that a considerable proportion of Integer divisions include very small numbers, which do not use the large width of 64 bit for example for the desired result precision. Further, such benchmarks have shown that the result of many Integer divisions is very often a relatively low number like 1, 2, . . . 20, or that it lies in a range smaller than 100. Thus, there is an enormous potential for saving computing cycles.

For the foregoing reasons, therefore, there is a need in the art for a method and respective system for calculating the quotient of two binary coded integer values, which in particular is able to save computing cycles when using small integer values.

### SUMMARY OF THE INVENTION

The shortcomings of the prior art are overcome and additional advantages are provided through the provision of a method and system for efficiently calculating the quotient of two small binary coded integer values.

In particular, a method is disclosed for calculating a quotient of a dividend and a divisor, the dividend and divisor being binary coded integer values, including normalizing the divisor and the dividend, determining a number of binary digits (nV) needed to represent the divisor and a number of binary digits (nD) needed to represent the dividend, determining a number of effective binary digits (nQ) needed to represent the quotient, determining a start bit position to start a subtraction-based divide process, and performing the subtraction-based divide process only for bit positions beginning at the start bit position and ending at a least signficant bit position.

In preferred embodiments of the present invention, the subtraction based divide process is an SRT Divide process.

Systems corresponding to the above-summarized methods are also described and claimed herein.

It is therefore an object of the present invention to provide a method and system for efficiently calculating the quotient of two small binary coded integer values.

The present invention is based on the following approach:

The Divisor must be normalized, i.e. its mantissa must be transformed to a form x.yyyyyyyyyy, in which x is not zero, before it is loaded into the SRT divide hardware. This is a basic requirement of the SRT algorithm and other methods, otherwise such algorithms do not converge.

The actual prior art hardware normalizes both the quotient and the divisor in the main floating-point dataflow. By that the information is basically available, how many bits (nV) in the divisor and how many bits (nD) in the dividend are used for the actual calculation. Having determined nV and nD, the number of Quotient digits (nQ) is calculated as:

n_{Q}=n_{D}−n_{V}+1 (1)

When nQ would be negative, the Quotient is always zero. The first bit on position nQ may be still a ‘1’ or a ‘0’, since this depends on the actual values of the operands and can not be precalculated on the basis of the used bits nD and nV only.

The Start value (nS) for a quotient format of for example 64 bits can now be calculated as:

n_{S}=n_{W}−n_{Q}=n_{W}−1−n_{D}+n_{V} (2)

where n_{W} is the width of an operand in bits, e.g. nw=64.

When a pointer to the Quotient Register can be freely chosen by respective control logic provided by the present invention, there is only a small additional hardware adder needed in the control logic, to implement this inventive start value determining function. Then, the actual divide process begins at the pre-calculated start position and is continued as done in prior art.

The end position is the lowest significant bit position, which may be set as a respective parameter, i.e. position 31 for 32-bit operands, or bit position 63 for a 64 bit operand.

Thus, according to the invention better performance is achieved, when the quotient has leading zeros, which is true for many applications, as up to 31 cycles can be saved in a 32 cycles comprising core division.

Further, according to the invention, the quotient has the correct alignment already in the quotient register, so no extra alignment is needed afterwards. This further saves computing cycles and additional alignment circuitry.

The present invention is independent of the actual implementation of the control flow when writing to the quotient register 20 as it focuses the improvements done by dynamically determining the start position of the divide process.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of a schematic block diagram showing the basic structural elements in a prior art SRT integer divide processor processing all digits between start position 0 and stop position 63 in an exemplary 64 bit wide quotient register;

FIG. 2 illustrates an example of a schematic block diagram depicting circuitry for computing a start position 62 and a stop position 63 for effectively processing the quotient register per an embodiment of the present invention, and

FIG. 3 illustrates an example of a block diagram representation depicting a control flow per an embodiment of the present invention.

### DETAILED DESCRIPTION

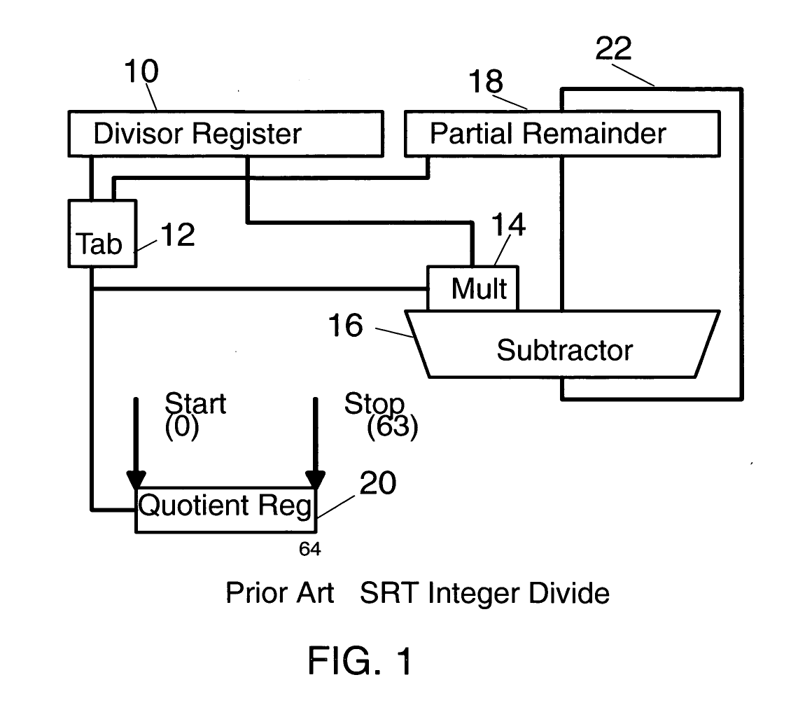

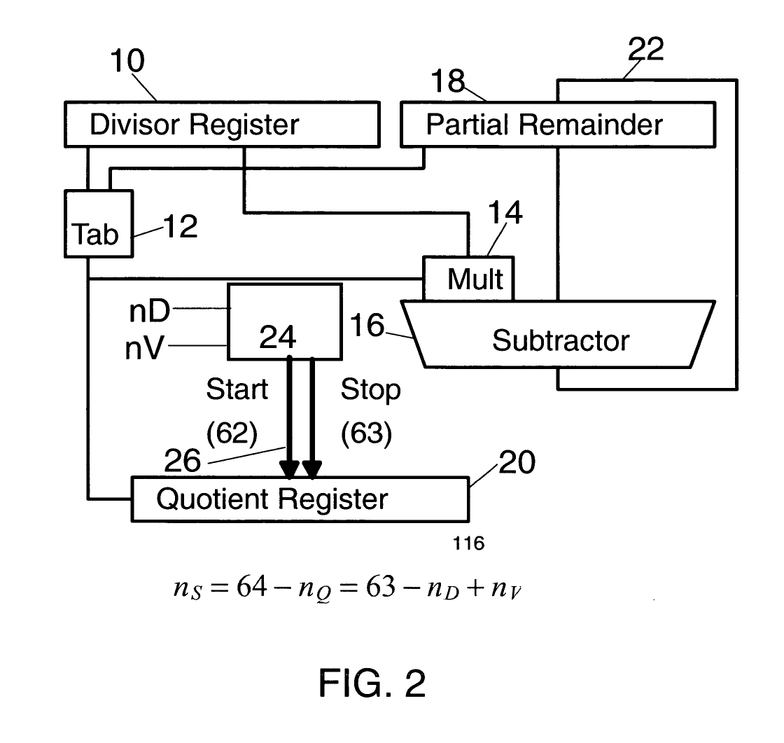

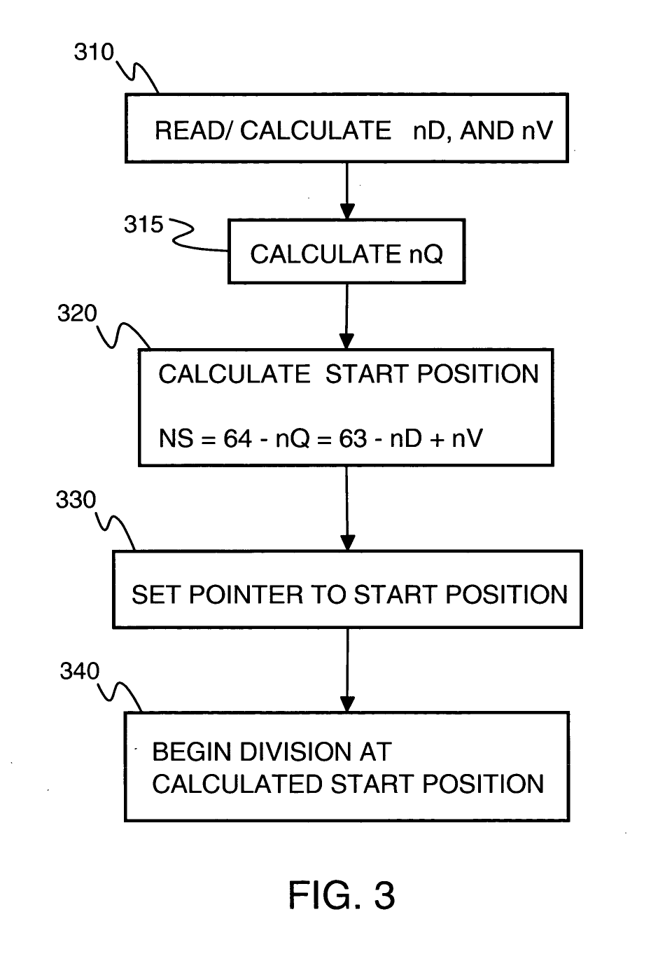

With general reference to the figures and with special, simultaneous reference now to FIG. 2 and FIG. 3, according to a preferred embodiment of the invention an adder logic circuitry depicted as having reference sign 24 is provided within a prior art SRT circuitry typified exemplarily and described above with reference to FIG. 1.

Adder 24 receives—step 310—input signals nD and nV as described further above from the normalizer circuitry normalizing the Dividend D and the Divisor V. Those values are generated and processed in prior art circuitry independently of the present invention. Thus, those values are read from a suited location in the normalizing circuitry. Those values are thus utilized at least twice, i.e. for normalization, and according to the invention for determining the start position for the divide process.

By thus determining nD and nV, the number of quotient digits (nQ) can be calculated—see step 315—as follows:

n_{Q}=n_{D}−n_{V}+1 (1)

which is done in the adder circuitry 24.

It should be noted that, when a comparison of the normalized Dividend (Dnorm) to the normalized Divisor (Vnorm) is done before, then the first calculated bit position of an ‘1’ in the quotient is also exactly defined and is determined by the following rules:

If Dnorm is greater than or equal to Vnorm then

n_{Q}=n_{D}−n_{V}+1 (1)

is valid.

Otherwise, If Dnorm is smaller than Vnorm then

n_{Q}=n_{D}−n_{V} (1A)

is valid.

It shoud be added that if nQ is negative, the Quotient is always set to zero.

The Start value (nS) for a quotient format, i.e. an operand bit length of nW=64 bits can thus be calculated—step 320—according to the invention as:

n_{S}=n_{W}−n_{Q}=n_{W}−1−n_{D}+n_{V} (2)

where n_{W} is the width of an operand in bits. This calculation is also performed in the adder circuitry 24.

According to the invention, then a pointer 26 to a bit position is generated and used—step 330—, the movement, setting of position of which is controlled by the above calculated start position nS. This is depicted in FIG. 2. The number nS is depicted to be 62 in FIG. 2. From this bit position the divide process starts—see step 340—in contrast to prior art, which starts always at the first bit position. Thus, assuming above prior art radix-4 SRT division for comparison a number of 62/2=31 iterations can be saved. If an iteration is done in one cycle, a number of 31 cycles is saved in this example.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for calculating a quotient of a dividend and a divisor, the dividend and the divisor being binary coded integer values, said method comprising:
normalizing the divisor and the dividend;
determining a number of binary digits (nV) needed to represent the divisor and a number of binary digits (nD) needed to represent the dividend;
determining a number of effective binary digits (nQ) needed to represent the quotient;
determining a start bit position to start a subtraction-based divide process; and
performing the subtraction-based divide process only for bit positions beginning at said start bit position and ending at a least significant bit position.

2. The method of claim 1, wherein the subtraction based divide process is an SRT Divide process.

3. The method of claim 1, wherein said determining a number of effective binary digits (nQ) includes calculating according to the formula:
nQ=nD−nV+1.

4. The method of claim 1, wherein the dividend and the divisor each contain a number of binary digits n_{W}, and said determining a start bit position includes a calculation according to the formula:
n_{S}=n_{W}−n_{Q}=n_{W}−1−n_{D}+n_{V}.

5. The method of claim 1, wherein the number of effective binary digits nQ is determined with a maximum error of 1 bit.

6. A system for calculating a quotient of a dividend and a divisor, the dividend and the divisor being binary coded integer values, said system comprising:
means for normalizing the divisor and the dividend;
means for determining a number of binary digits (nV) needed to represent the divisor and a number of binary digits (nD) needed to represent the dividend;
means for determining a number of effective binary digits (nQ) needed to represent the quotient;
means for determining a start bit position to start a subtraction-based divide process; and
means for performing the subtraction-based divide process only for bit positions beginning at said start bit position and ending at a least significant bit position.

7. The system of claim 6, wherein the subtraction-based divide process is an SRT divide process.

8. The system of claim 6, wherein said means for determining a number of effective binary digits (nQ) includes means for calculating according to the formula:
nQ=nD−nV+1.

9. The system of claim 6, wherein the dividend and the divisor each contain a number of binary digits n_{W}, and said means for determining a start bit position includes means for performing a calculation according to the formula:
n_{S}=n_{W}−n_{Q}=n_{W}−1−n_{D}+n_{V}.

10. The system of claim 6, wherein the number of effective digits nQ is determined with a maximum error of 1 bit.

11. A system for calculating a quotient of a dividend and a divisor, the dividend and the divisor being binary coded integer values, said system comprising:
a normalizing circuit, said normalizing circuit receiving as input the divisor and the dividend, said normalizing circuit providing as output a normalized divisor, a normalized dividend, a number of binary digits (nV) needed to represent the divisor, and a number of binary digits (nD) needed to represent the dividend;
an adder circuit, said adder circuit receiving as input nV and nQ, said adder circuit providing as output a number of effective binary digits (nQ) needed to represent the quotient, and a start bit position at which to start a subtraction-based divide process; and
a floating point divide processor, said processor receiving as input the normalized divisor, the normalized dividend, and the start bit position, said processor providing said quotient as output by performing the subtraction-based divide process only for bit positions beginning at said start bit position and ending at a least significant bit position.

12. The system of claim 11, wherein the subtraction-based divide process is an SRT divide process.

13. The sytem of claim 11, wherein said adder calculates the number of effective binary digits (nQ) according to the formula:
nQ=nD−nV+1.

14. The system of claim 11, wherein the dividend and the divisor each contain a number of binary digits n_{W}, and said adder calculates the start bit according to the formula:
n_{S}=n_{W}−n_{Q}=n_{W}−1−n_{D}+n_{V}.

15. The system of claim 11, wherein the number of effective digits nQ is determined with a maximum error of 1 bit.
